(19) United States
(12) Patent Application Publication
(10) Pub. No.: US 2008/0025466 A1
(43) Pub. Date: Jan. 31, 2008

(54) Apparatus for determining the position and orientation of an x-ray source

(75) Inventors: Charles G. Peterfy, Kentfield, CA (US); David L. White, Oakland, CA (US); Manish Kothari, San Rafael, CA (US); Gabriele von Ingersleben, Alameda, CA (US); Martine M. Sieffert, San Francisco, CA (US); Julie Camille DiCarlo, Menlo Park, CA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Synarc, Inc., San Francisco, CA (US)

(21) Appl. No.: 11/492,437

(22) Filed: Jul. 25, 2006

(51) Int. Cl. H05G 1/28

(52) U.S. Cl. 378/162

(57) ABSTRACT

A frame for determining the position and orientation of an x-ray source relative to an x-ray cassette during x-radiography. In one embodiment the frame includes an x-ray transparent or translucent plate having a first surface and a second surface; and a partially radio-opaque protrusion positioned on the first surface of the plate. In another embodiment, a method for determining the position and orientation of an x-ray source relative to an x-ray cassette is disclosed. The method includes the steps of providing a frame, including an x-ray transparent plate having a first surface and a second surface; and a protrusion having a radio-opaque portion positioned on the first surface of the plate, and placing the plate on the x-ray cassette such that the second surface is in contact with the x-ray cassette. The method further includes placing the appendage on the plate in close juxtaposition to the protrusion, exposing the appendage and plate to an x-ray beam, and examining the image formed.

### FIELD OF THE INVENTION

The invention relates generally to the field of x-radiography and specifically to the determining of the position and orientation of an x-ray source.

### BACKGROUND OF THE INVENTION

One of the challenges of radiography of the hands and feet is ensuring accurate labeling of the right and left sides. Currently, this is done by manually placing radio-opaque markers on the radiographic cassette at the time of film exposure. However, it is virtually impossible to verify retrospectively whether this was done correctly. In some cases, the presence of fortuitous anatomical asymmetries, such as remote unilateral fracture, provides definitive indicators of side, but these are rare and require additional discipline, effort and expertise on the part of the image interpreter.

Errors in right-left labeling can lead to misinterpretations of images. In clinical practice, this can result in serious mistakes in patient management, including surgical intervention. In a clinical trial setting, right-left mismatches between serial radiographs of the hands, wrists or feet of patients with rheumatoid arthritis can result in misinterpretation of progression of structural damage (bone erosion and joint-space narrowing) and therefore disease severity or treatment response. Inappropriately changing disease-modifying therapy in response to erroneous radiographic information can increase the cost and toxicity risk of treatment or result in under-treating progressively destructive rheumatoid arthritis, exposing patients to preventable joint of new therapies for rheumatoid arthritis can result in poor decision making by pharmaceutical companies and regulatory agencies leading to approval of ineffective therapies or rejection of effective ones. Accordingly, a fail-safe method for accurately labeling the right and left side in radiography of the hands, wrists and feet is an important unmet need in radiography today.

### SUMMARY OF THE INVENTION

The invention relates to a frame for determining the position and orientation of an x-ray source relative to an x-ray cassette during x-radiography. In one embodiment the frame includes an x-ray transparent or translucent plate having a first surface and a second surface; and a partially radio-opaque protrusion positioned on the first surface of the plate.

Still yet another aspect of the invention is a method for determining the position and orientation of an x-ray source relative to an x-ray cassette. In one embodiment the method includes the steps of providing a frame, including an x-ray transparent plate having a first surface and a second surface; and a protrusion having a radio-opaque portion positioned on the first surface of the plate, and placing the plate on the x-ray cassette such that the second surface is in contact with the x-ray cassette. The method further includes placing the appendage on the plate in close juxtaposition to the protrusion, exposing the appendage and plate to an x-ray beam, and examining the image formed.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a perspective view of an embodiment of a frame constructed in accordance with the invention, positioned above an x-ray cassette;

FIG. 2 is a side view of the frame of FIG. 1 with a hand positioned upon it;

FIG. 3 is a plan view of another embodiment of the frame constructed in accordance with the invention;

FIG. 4 is a plan view of yet another embodiment of the frame constructed in accordance with the invention;

FIG. 5a is perspective view of an embodiment of a frame constructed in accordance with another embodiment of the invention;

FIG. 5b is a plan view of the plate of FIG. 4A from an orthogonal view point directly above the plate;

FIG. 5c is a plan view of the plate of FIG. 4A from a non-orthogonal view point above the plate; and

FIG. 5d illustrates two overlapping orthogonal plan views of the plate of FIG. 4a at two different magnifications.

### DESCRIPTION OF A PREFERRED EMBODIMENT

This application incorporates by reference the co-pending U.S. patent application “An Apparatus for Positioning and Labeling an Appendage in X-Radiography” (Attorney docket number SYN-002A), assigned to the assignee of the present invention and filed simultaneously herewith.

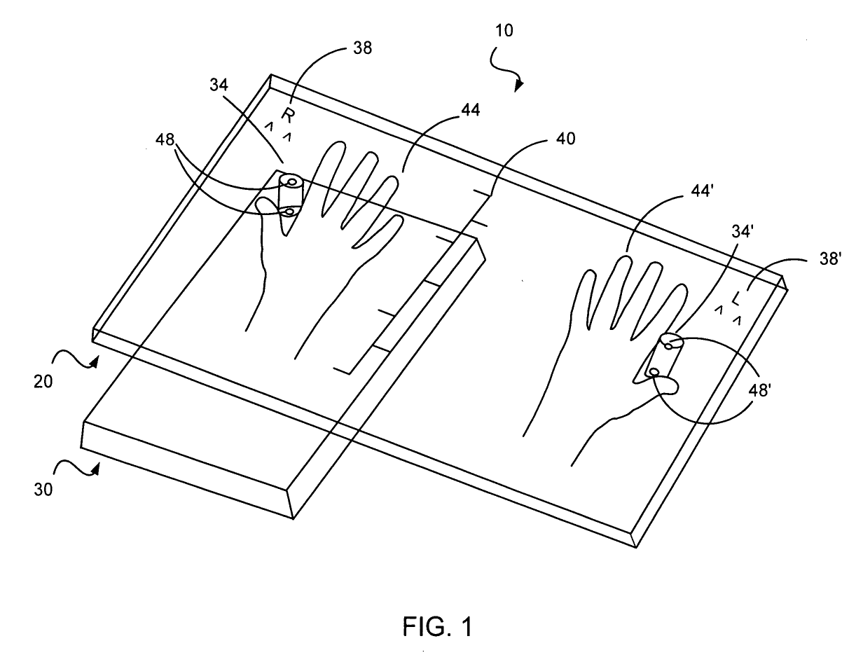

Referring to FIG. 1, an embodiment of a frame 10 constructed in accordance with the invention includes a flat radio-translucent or transparent plate 20 that is sized and shaped for placement on top of a radiographic cassette 30. The radiographic cassette 30 may contain x-ray film or may itself be a digital detector for use. On the top surface of the plate 20 are one or more protrusions (in this embodiment, pegs) 34, 34′ that prevent the frame 10 from being positioned upside down and also serve as guides for palmar and plantar placement of the hand or foot, respectively. In the embodiment shown, one plate 20 is configured with both right and left appendages on the same plate 20. The plate 20 in this embodiment is approximately twice the width of the cassette 30 and hence either the left or the right half of the plate 20 is positioned on the cassette 30 of a given time. Other embodiments may be configured for use solely with the right or left hand or foot. Accordingly, the plates in these embodiments have the same width as the cassette. The protrusions or pegs 34, 34′ prevent positioner from lying flat on the cassette 30 when one attempts to place the frame 10 upside-down. This has the consequence of preventing inversion errors, which have the effect of displaying a planar representation of an object as its mirror image. (This is what happens when a radiograph is “flipped”; absent an “R”/“L” marker, there is no way of unequivocally determining whether the radiograph of a hand is of a left or a right hand.)

In one embodiment, “R” and “L” radio-opaque markers 38, 38′ are permanently affixed to the plate 20. The fact that both the radio-opaque markers 38, 38′ and the hand (or foot) are each asymmetric and chiral (that is, an object's mirror image is not superimposable upon the object itself) means that handedness (Right/Left) of a hand (or foot) can be determined unequivocally when its x-ray image is obtained in conjunction with the radio-opaque markers 38, 38′.

In another embodiment, radio-opaque fiducial markers, rulers 40, and/or appropriately oriented radio-translucent indicia of the hand 44, 44′ and foot alignment marks are also affixed to one of the surfaces of the plate 20. In still yet another embodiment, radio-opaque beads 48, 48′ may be positioned on the proximal and/or distal poles of one or more radio-translucent pegs 34, 34′. By comparing the projected positions of these beads 48, 48′ relative to one another and/or those of the “R”/“L” markers 38, 38′ or other fiduciary markers 34, 34′ on serially acquired radiographs, one can determine whether the beam centering and angulation used on the serial images are the same. This assists the reader in differentiating true anatomical changes from those due to projectional variations and is described in more detail below.

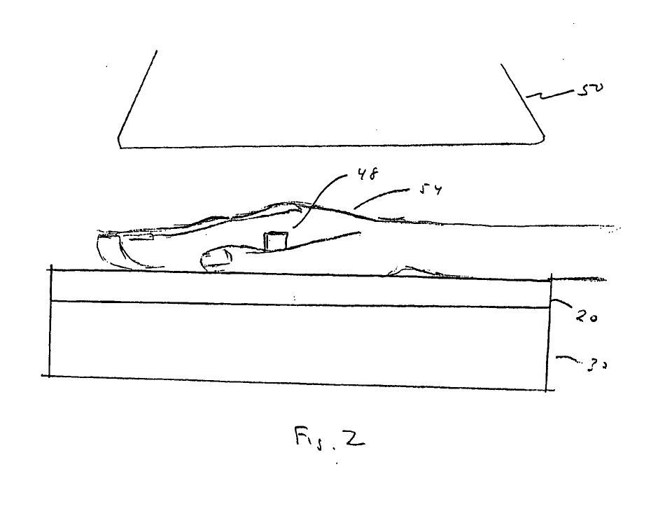

In use and referring to FIG. 2, wrist-hand radiographs are typically obtained with the patient seated with his forearm and hand horizontal to his side. The frame 10 is placed on the x-ray film cassette 30, with the surface opposite the protuberance 48 placed against the cassette 30. The cassette 30 and frame 10 are placed on the table of the x-ray machine, with the x-ray source 50 above. The patient's hand 54 is placed on the frame 10 adjacent the protuberance 48 with the palm against the surface of the plate 20. This exposure is dorsal-palmar.

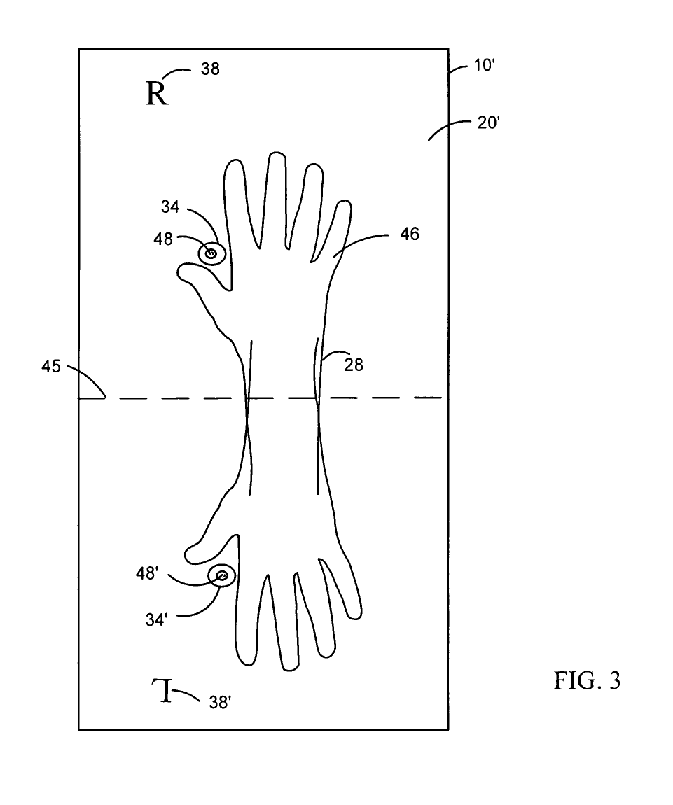

Another embodiment of the frame 10 is shown in FIG. 3. In this embodiment, the frame 10 has approximately the same width as the cassette (or a hand), but nevertheless may be used for both the left and right appendages. Instead of having separate radio-translucent alignment marks 44, 44′ for the right and left hands on a frame 10 approximately twice the width of the cassette 30 as shown in FIG. 1, the plate 20′ illustrated in FIG. 3 contains a single radio-translucent mark 46 shaped as a left and a right hand overlapping each other with their palms and pointing in opposite directions such that the thumbs on both hands are on the same side of the plate 20′. As a result, the outline of the mark 46 is symmetrical as to an imaginary line 45 across the middle of the plate 20′.

Still referring to FIG. 3, similar radio-opaque markers, such as pegs 34, 34′, “R”/“L” markers 38, 38′, and beads 48, 48′ positioned on proximal and/or distal poles of the pegs 34, 34′, may also be placed on the plate 20′ to verify the handedness of appendages and to prevent the plate 20′ from being placed upside-down on a cassette when in use. In this embodiment, a radio-opaque “R” marker 38 is placed on the thumb side of the right hand outline, and an inverted radio-opaque “L” marker 38′ is placed on the thumb side of the left hand outline. As shown in FIG. 3, the “R”/“L” markers 38, 38′ are respectively on the top and bottom left corners of the plate 20′. Similarly, two radio-opaque pegs 34, 34′ are each positioned between the thumbs and the index fingers of the outline 46 of the right and left hand respectively. For a right hand radiograph, the frame 10′ is positioned over the top of a cassette so that the right hand can be comfortably placed palm down on top of the frame 10′ in alignment with the right hand half of the outline 46 on the plate 20′ with the upright “R” marker 38 next to the thumb. The plate 20′ may be rotated 180 degrees about its center so that a left hand radiograph may be taken by positioning the left hand palm down on top of the frame 10′ in alignment with the left hand half of the outline 46 with the upright “L” 38′ next to the thumb.

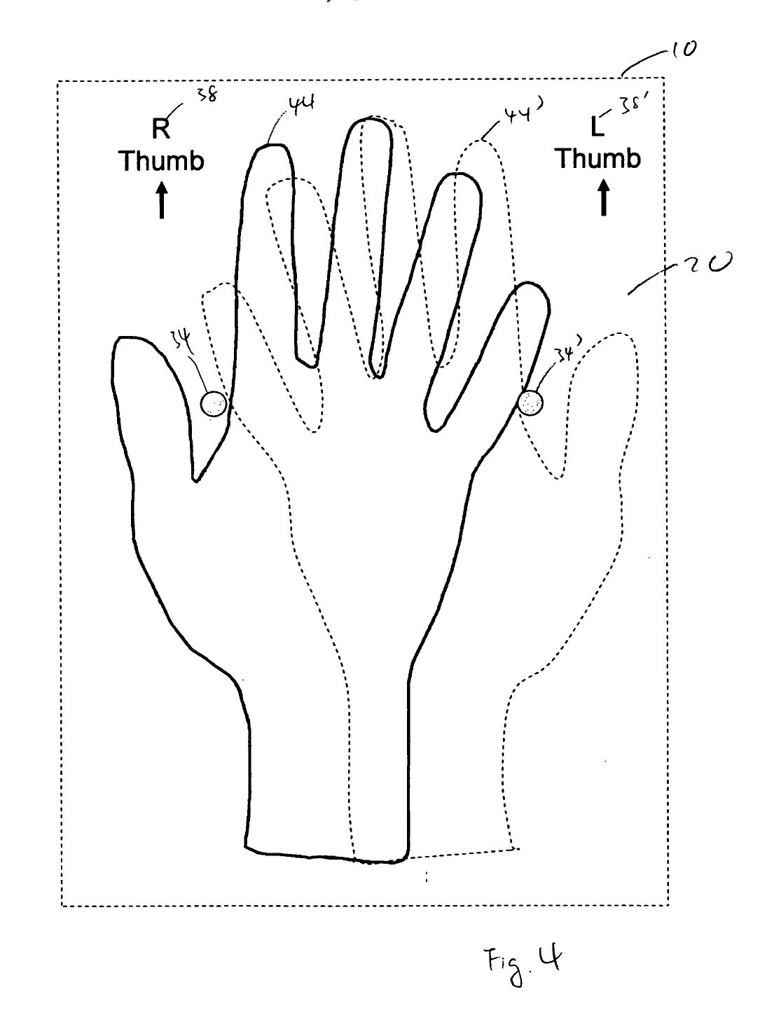

Yet another embodiment of the frame 10 is shown in FIG. 4. Similar to the previous embodiment, the frame 10 also has approximately the same width as the cassette (or a hand) and can be used for both the left and right hands. However, in this embodiment, the two overlapping radio-translucent marks 44, 44′, shaped as a left hand and a right hand respectively, point in the same direction. As such, the thumb of the right hand appears on the left side of the plate 20 and the thumb of the left hand appears on the right side of the plate 20. A radio-opaque “R” marker 38 is placed on the right thumb side and a radio-opaque “L” marker 38′ is placed on the left thumb side also to indicate the handedness of the appendages positioned on the plate. Similarly, radio-opaque pegs 34, 34′ may be positioned between the thumbs and the index fingers of the outlines of the right and left hand respectively. Unlike the frames 20 discussed in the previous embodiments, the frame 20 illustrated in FIG. 4 does not have to be rotated or translated when used for taking radiographs of both hands.

Regardless of which embodiment of the frame is used, the combination of pegs 34, 34′, permanently affixed radio-opaque “R” 38 and “L” 38′ labels and, optionally, radio-translucent outlines of hands 44, 44′, 46 and feet make incorrect placement of the hand (foot) immediately obvious to the user. Even if the user persists in incorrectly locating the hand (foot) on the positioner, the mistake(s) will be readily discernable on the resulting radiographs, and the true right/left identity of the hand (foot) can be ascertained from the radiographic image alone. This invention makes mistaken positioning of appendage readily discernable.

These points are illustrated in the following examples.

When correctly positioned, the fingers of the radio-translucent tracing point forward and the appropriate “R” or “L” label appears above the thumb. For the right wrist/hand, for example, the left end of the positioner is next to the patient. This locates the “R” radio-opaque marker above the right thumb.

The effect of horizontal translation of the frame is a noticeably more awkward position for the patient, which in itself will discourage this error. Additionally, the hand will not match the radio-translucent hand outline. However, a radiograph obtained in this manner will be immediately identifiable, as the “R” or “L” marker will appear right-side-up above the little finger. Note that the marker will be incorrect; the right hand will have an “L”, and vice-versa.

If a rotation of the frame is made about its center, the hand will not match the radio-translucent hand outline, and a radiograph obtained in this manner also will be immediately identifiable. In this case, the “R” or “L” marker will appear upside down (pointed away from the direction of the fingers) beneath the thumb. Note that the marker will be incorrect; the right hand will have an “L”, and vice-versa.

The effect of rotation and translation of the frame is that the hand will not match the radio-translucent hand outline, and a radiograph obtained in this manner also will be immediately identifiable. In this case, the “R” or “L” marker will appear upside down (pointed away from the direction of the fingers) beneath the little finger. Note that the marker will be correct; the right hand will have an “R”, and vice-versa.

Foot radiographs are usually obtained with the patient lying supine on the table of the x-ray machine. The knee is flexed so that the foot is placed flat upon the frame which is in turn placed on the x-ray film cassette with the x-ray source above. The exposure is dorsal-plantar. Analogously to the hand, correct use of the frame places the appropriate “R” or “L” marker immediately adjacent to the great toe.

The appearance of the hand (foot) and radio-opaque label in radiographs obtained with the combinations of hand (foot) location with respect to the frame are summarized in Tables 1 and 2. Thus, the positioning and labeling frame disclosed herein solves the problem of unequivocally labeling right and left in hand and foot radiographs.

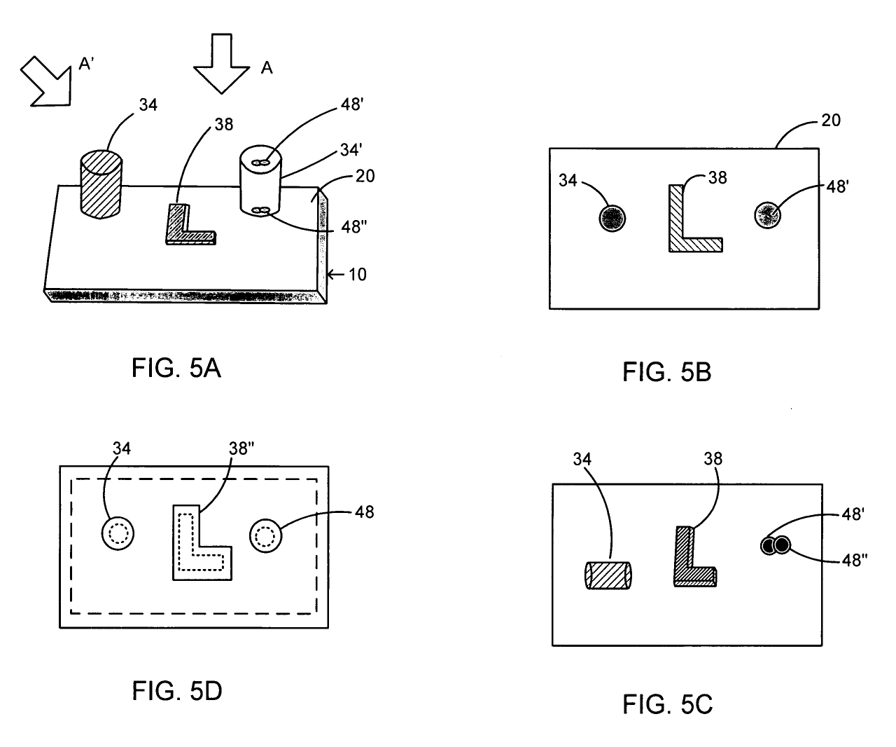

Not only do the embodiments of the invention accurately label the right and left side in radiography of the hands, wrists and feet, the embodiments can also indicate whether the beam centering, magnification and angulation used on the serial images are the same. FIGS. 5a, 5b, 5c and 5d illustrate that by comparing the projected positions of the radio-opaque markers, one can differentiate true anatomical changes from those due to projectional variations.

FIG. 5a is a perspective view of a frame 10 with a plurality of different radio-opaque markers capable of determining the magnification, centering and angulation of the x-ray source relative to the plate. Each of the three markers used in this embodiment of the frame are used for indicating the handedness of an appendage and may be used individually or in combination with one another. A radio-opaque perpendicular peg 34, a radio-opaque “L” marker 38, and a radio-translucent perpendicular peg 34′ with radio-opaque bead 48′, 48″ on its proximal and distal end, are affixed to the first surface of the plate 20.

FIG. 5b is a plan view of the plate 20 in FIG. 5a. The x-ray source is positioned is orthogonally above the plate 20 (arrow A in FIG. 4a) so that the line of sight is perpendicular to the surface and the three markers 34, 48′, 38 thereon. As a result, the top and bottom surfaces of the markers 34, 48′, 38 are aligned and the x-ray beam is blocked by the markers. In the radiography context, this view represents a radiograph taken when the radiation source is positioned perfectly perpendicular to the surface.

However, if the radiation source is angularly displaced, tilted slightly, (arrow A′ in FIG. 5a) the radiation impinges on the markers at an angle different from perpendicular. As a result a different view of the same markers 34, 48′, 38 is obtained. As shown in FIG. 5c, because all three markers are radio-opaque, there are elongated images, like shadows of each of them projected on the plate 20. The differences in the two images (FIGS. 5b and 5c) are not the result of any changes to the markers 34, 48′, 38 themselves, but of changes in the angulation of the radiography—the angle between the radiation source and the plate. When a radiation source is not positioned perfectly perpendicular to the plate, a different image will be captured even though the object under radiation remains the same. As illustrated, the use of the radio-opaque markers on plate constructed in accordance with an embodiment of the invention makes it possible to visually identify such changes in angulation, as demonstrated by the comparison of FIGS. 5b and 5c. So for example radio-opaque peg 34 appears elongated when the x-ray image is not perpendicular. Similarly, the images of the two beads 48′ and 48″ located at the ends of peg 34 are no longer superimposed when the source is at an angle to the plate but instead appear as two spots. Finally, the image of the letter “L” 38 appears distorted because of the angulation. Thus the fact that the x-ray source is not perpendicular to the plate is easily detected.

Referring to FIG. 5d, serial images of the same appendage taken using an embodiment of the present invention may also be compared to see whether the differences in the images are due to changes in magnifications instead of true anatomical changes to the appendage. FIG. 5d illustrates two overlapping plan views of the same plate 20 on which the same markers 34, 48, 38 are attached. As outlined by dotted and solid lines respectively, the two images do not perfectly overlap each other. The solid line view looks to be a magnified image of the dotted line view as a result of the different distances at which the source was positioned from the plate 20. The markers 34, 48, 38 outlined by dotted lines represent a view from a more distant view point in the same line of sight, and the solid lines represent a closer view of the plate 20. By comparing the relative sizes of the images, one reading the x-ray can determine that the relative sizes are different and hence the magnification is different, when the same sized markers are used for each image.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method for determining the position and orientation of an x-ray source relative to an x-ray cassette comprising the steps of:
providing a frame comprising:
an x-ray transparent plate having a first surface and a second surface; and
a protrusion having a radio-opaque portion positioned on said first surface of said plate;
placing said plate on said x-ray cassette such that said second surface is in contact with the x-ray cassette;
placing said appendage on said plate in close juxtaposition to said protrusion;
exposing the appendage and plate to an x-ray beam; and
examining the image formed.

2. The method of claim 1 wherein the protrusion is an indicium of handedness.

3. The method of claim 1 wherein the step of examining determines angularity of the source relative to the plate.

4. The method of claim 1 wherein the step of examining determines the magnification of the x-ray image.

5. A frame for determining the position and orientation of an x-ray source relative to an x-ray cassette, the frame comprising:
an x-ray transparent or translucent plate having a first surface and a second surface; and
a partially radio-opaque protrusion positioned on the first surface of said plate.

6. The frame of claim 5 wherein the partially radio-opaque protrusion is substantially totally radio-opaque.

7. The frame of claim 5 wherein the partially radio-opaque protrusion is an indicium of handedness.

8. The frame of claim 5 wherein the partially radio-opaque protrusion comprises a peg having an opaque portion at one end.
